(19) United States
(12) Patent Application Publication
(10) Pub. No.: US 2020/0114880 A1
(43) Pub. Date: Apr. 16, 2020

(54) CLEANING DEVICE FOR CLEANING A TRANSPARENT COVER OF AN OPTICAL OR OPTOELECTRONIC DEVICE

(71) Applicant: Continental Automotive GmbH, Hannover (DE)

(72) Inventor: Torsten Hahn, Homberg (DE)

(21) Appl. No.: 16/604,404

(22) PCT Filed: Apr. 5, 2018
(86) PCT No.: PCT/EP2018/058695

§ 371 Date: Nov. 6, 2019

(30) Foreign Application Priority Data
Apr. 11, 2017 (DE) 10 2017 206 211.8
Apr. 13, 2017 (DE) 10 2017 206 454.4
Dec. 20, 2017 (DE) 10 2017 223 393.1

(51) Int. Cl. B60S 1/56; B60S 1/52; B60S 1/54; G02B 27/00

(52) U.S. Cl. CPC B60S 1/56; G02B 27/0006; B60S 1/54; B60S 1/52

(57) ABSTRACT

A cleaning device for cleaning a transparent element of an optical or optoelectronic device with a fluid cleaning agent, includes a housing in which the device is arranged, at least one fluid inlet arranged in the housing, and at least one nozzle supplied from the fluid inlet. The nozzle is designed to deflect a cleaning agent jet onto the transparent element, and the jet direction of the cleaning agent jet is substantially transverse to an optical axis of the transparent element. The fluid inlet is designed for a throughflow of a cleaning liquid out of a hydraulic channel and compressed air out of a pneumatic channel. The hydraulic channel has a hydraulic nonreturn valve, and the pneumatic channel has a pneumatic nonreturn valve, the nonreturn valves opening the channels in the direction of the nozzle and blocking the channels in the opposite direction.

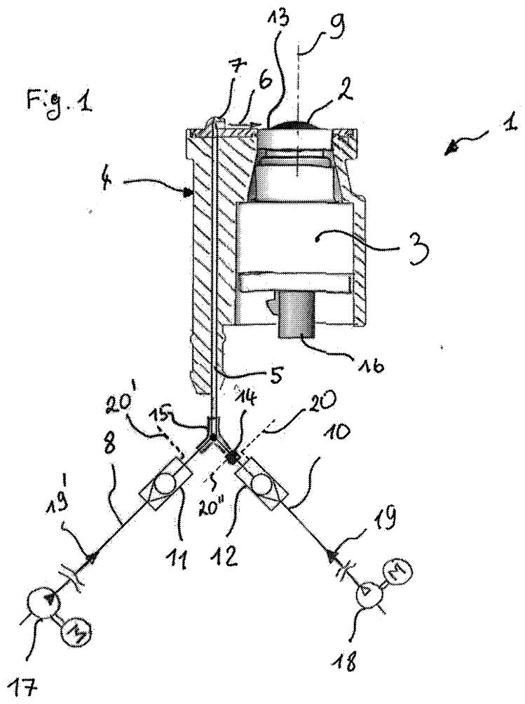

### CROSS REFERENCE TO RELATED APPLICATIONS

This application is the U.S. National Phase Application of PCT International Application No. PCT/EP2018/058695, filed Apr. 5, 2018, which claims priority to German Patent Application No. 10 2017 206 211.8, filed Apr. 11, 2017, German Patent Application No. 10 2017 206 454.4, filed Apr. 13, 2017 and German Patent Application No. 10 2017 223 393.1, filed Dec. 20, 2017, the contents of such applications being incorporated by reference herein.

### FIELD OF THE INVENTION

The invention relates to a cleaning device for cleaning a transparent element of an optical or optoelectronic device, in particular of a camera lens, as well as an optical capture system for arrangement in a vehicle, comprising one or more cleaning devices with optical or optoelectronic devices.

### BACKGROUND OF THE INVENTION

Today, motor vehicles increasingly have assistant systems with sensors installed, which are intended to support the vehicle user in driving the vehicle while reliably capturing and monitoring the environment of the vehicle.

For this purpose, such assistant systems include optical or optoelectronic devices such as in particular cameras, but also laser-based or infrared sensors, which are attached to the outside of the vehicle. The basic functions of such devices are manifold and include from simple help functions such as for example representation of areas obscured by the vehicle on a display and parking assistance to delivery of input data for autonomous and fully automated driving functions.

Such devices are provided with transparent elements such as lenses or covers, which allow light to pass through without restriction or in a specific restricted wave range, depending on the application case. Such transparent elements often have an outwardly convex or curved design, for example, in order to allow a particularly wide capture range for a camera such as, for example, so called fisheye cameras. Furthermore, for functional reasons, such transparent elements are arranged on the outside of the vehicle and therefore exposed to contamination and external weather impacts and must be cleaned as necessary to ensure functionality.

A generic cleaning device is known from DE 10 2015 217 546 B3, for example, and incorporated herein by reference. The transparent cover is here the lens of a digital camera. The lens is sprayed with liquid cleaning agent transversely to its optical axis from three circumferentially distributed nozzles designed as deflector nozzles.

Frequent cleaning intervals result in a correspondingly high consumption of cleaning liquid from a limited supply to be carried on board. In order to extend refill intervals, large storage tanks have to be provided with disadvantages for the space efficiency, weight and cost.

Besides contamination, undesired optical distortions of the camera image can also be caused by simple water drops on the camera lens.

### SUMMARY OF THE INVENTION

In light of this, an aspect of the present invention is an improved cleaning device, which allows to increase and ensure the availability and functional reliability of the optical and optoelectronic devices used in all weather conditions and operating states and preferably at all times as well as with a reduced use of cleaning liquid.

According to an aspect of the invention, the fluid inlet is designed for a throughflow of a cleaning liquid out of a hydraulic channel and compressed air out of a pneumatic channel. As such, the hydraulic channel has a hydraulic nonreturn valve and the pneumatic channel has a pneumatic nonreturn valve, which open the channels in the direction of the nozzle and block the channels in the opposite direction.

Thus, a cleaning strategy optimally adapted to the relevant operating and environmental conditions with exclusively compressed air, cleaning liquid or a mixture of both can be realized in a particularly simple manner. The use of air, which is freely available from the atmosphere and therefore unlimited, as a cleaning fluid results in substantially more infrequent cleaning cycles with cleaning liquid, which may even become completely superfluous, depending on the installation position in the vehicle. The overall consumption of cleaning liquid is reduced. Installation space, weight and cost are saved due to smaller cleaning liquid storage tanks.

In this respect, the cleaning device, together with the optical or optoelectronic device, the channels and nonreturn valves can be implemented as an integrated component, which can be universally installed in different installation positions in the vehicle. The logistics and final assembly on the vehicle are simplified.

According to a preferred further embodiment of the invention, the transparent element has an outwardly curved design. The cleaning agent jet is thus substantially directed to a radial outer edge of the transparent element so as to utilize the Coanda effect. In this respect it is particularly advantageous, if the cleaning agent jet is designed as a flat jet, which substantially spreads in a plane orthogonal to the optical axis.

Thus, the entire surface of the transparent element is effectively flushed and cleaned at a comparably low pressure and with a reduced liquid requirement. The nozzle can be designed as a particularly simple and flat deflector nozzle. In addition to simplifying the construction, the effect on the look and feel of outer surfaces on the vehicle—for example, if installed in a door or tailgate handle—is minimal. The consumption of cleaning liquid is also reduced.

According to a preferred embodiment of the invention, the operating pressure of the cleaning liquid in the hydraulic channel is provided to be greater than an operating pressure of compressed air in the pneumatic channel.

Due to the comparably higher pressure of the cleaning liquid, if required, the compressed air can be overridden at any time by simply unblocking the hydraulic channel, if, for example, the cleaning effect with compressed air is not sufficient. The limited cleaning liquid supply can thus be consumed particularly economically. Additional blocking and control devices can be omitted.

Preferably, the operating pressure of compressed air can be provided within a range between 0.8 bar and 1.2 bar, in particular at approximately 1 bar. Thus, an optimal compromise between effective and cost-efficient compressed air generation, simple materials for pneumatic channels and lines and a good cleaning result can be realized.

According to another embodiment according to the invention, the pneumatic nonreturn valve in particular can be of electrically controlled design for targeted control of a throughflow of air flow.

For example, this allows for particularly effective demand-based adjustment of the air supply for individual cleaning devices within a connected cleaning system containing several cleaning devices, with a single shared compressed air generator.

According to another embodiment according to the invention, a dosing valve can be provided in the pneumatic channel for controlled variation of a compressed air amount entering the fluid inlet, to allow for a particularly sensitive, demand-based modulation of air flow, regardless of the operating state of the compressed air generator.

Furthermore, according to an aspect of the invention, the compressed air is supplied to the fluid inlet in a continuously flowing manner. The permanent air purge that can thus be caused can prevent contamination of the transparent element. Generally less dust reaches its surface, small dirt particles and water drops are immediately removed. As a result, less cleaning intervals with cleaning liquid are required, the volume of storage tanks can be reduced.

Similarly, according to an aspect of the invention, the compressed air can be supplied to the fluid inlet in a pulsed intermittent manner. The thus generated air pulses can be used to remove water drops and larger dirt particles without the use of cleaning liquid.

An aspect of the invention further relates to an optical capture system for arrangement in a vehicle, comprising at least one, preferably more, cleaning devices according to an aspect of the invention.

### BRIEF DESCRIPTION OF THE DRAWINGS

In the following, an aspect of the present invention will be explained by way of example with reference to exemplary embodiments of an improved cleaning device for a camera lens according to an aspect of the invention summarized in the FIGURE.

### DETAILED DESCRIPTION OF THE PREFERRED EMBODIMENTS

An optical device 3 implemented as a camera with a transparent 2 element designed as a camera lens is arranged in a housing 4 of the cleaning device 1. An electrical interface 16 serves for connection of the device 3 to one or more electrical supply means and control units (not shown). The transparent element 2 is outwardly curved and has an optical axis 9.

A fluid inlet 5 serves for supplying a single nozzle 7 with cleaning fluid. Within the scope of an aspect of the invention, the use of several nozzles 7 remains admissible at any time.

The nozzle 7 is designed as a deflector or deflector nozzle. It forms a flat cleaning agent jet 6, which spreads transversally to the optical axis 9 in a plane substantially orthogonal thereto. The cleaning agent jet 6 is here directed such that it hits the transparent element 2 approximately at its radial outer edge 13.

Here, a property of fluid flows to follow the course of a convex surface, in fluid mechanics known as Coanda effect, is utilized. Due to the Coanda effect, the cleaning agent jet 6 envelops the curved surface of the transparent element 2 cleaning it completely, instead of coming away or being deflected from it.

At its end opposite to the nozzle 7, the fluid inlet 5 is connected to a hydraulic channel 8 and a pneumatic channel 10.

Out of the hydraulic channel 8, the fluid inlet 5 is supplied with a cleaning liquid, which is delivered from a storage tank (not shown) by an electrically driven pump 17.

Out of the pneumatic channel 10, the fluid inlet 5 is supplied with compressed air, which, depending on the embodiment according to the invention, is either generated in a separately associated compressed air generator 18, as shown, or tapped from another source, such as, for example, vehicle ventilation system, compressed air tank, suspension system compressor and the like.

Depending on the operating state, the throughflow through the fluid inlet 5 may comprise exclusively cleaning liquid, exclusively air or a mixture of both.

As such, it is not relevant for an aspect of the invention whether the two channels 8,10 are designed next to each other in a shared component or are connected to the fluid inlet 5 as individual separate lines through a suitable connector 15—for example, a Y piece. However, it is particularly advantageous and efficient for assembly, if the two nonreturn valves 11, 12 together with adjacent sections of the channels 8, 10 and the fluid inlet 5 are provided to be integrated in the housing 4.

A nonreturn valve 11, 12 is each installed in the hydraulic channel 8 and the pneumatic channel 10 such that the respective channel can be blocked against the flow direction 19, 19′.

Depending on the embodiment according to the invention, the nonreturn valves 11, 12 can either be designed as simple or as electrically or electromagnetically controllable nonreturn valves, which can be controlled via an associated control line 20, 20′ 20″ thereby allowing for the relevant cleaning liquid or air flow to be modulated in a targeted manner.

As an option, a dosing valve 14 can be installed in the pneumatic channel 10, which would allow the air flow flowing into the fluid inlet to be modulated in addition to or instead of the controllable nonreturn valve 12. As such, the dosing valve 14 can be designed as an electrically controllable shut-off or throttle valve, for example.

Upon targeted interruption of the supply with cleaning liquid and opening of the pneumatic nonreturn valve 12, the throughflow through the fluid inlet will comprise exclusively compressed air. Here, an air pressure in a pressure range between approximately 0.8 and 1.2 bar, preferably ˜1 bar, has proven particularly suitable for the desired use. The limitation of the pressure can be realized by a corresponding design of the compressed air generator 18 and the pneumatic nonreturn valve 12.

The air flow can be delivered in different manners, for example, continuously or in an intermittently pulsing or otherwise modulated manner, as required. Depending on the embodiment, the modulation can be achieved by controlling either the compressed air generator 18, the pneumatic nonreturn valve 12 or the dosing valve 14.

In case of a continuous supply of compressed air, the transparent element 2 is permanently flushed with air flow, in case of a pulsed supply, individual air pulses are blown at it.

According to an aspect of the invention, the pressure of cleaning liquid in the hydraulic channel 8 is to be designed higher than the air pressure in the pneumatic channel 10, for example, by a corresponding design of the pump 17. Thus, the supply of the nozzle 7 with cleaning liquid can occur at any time by controlling the pump 17 or controlled opening of the hydraulic nonreturn valve 11. Due to the low inherent pressure, the air flow is then simply offset or overridden. The nonreturn valve 12 is hereby closed, thus preventing the cleaning liquid from entering the pneumatic channel 10.

### LIST OF REFERENCE NUMERALS

1 Cleaning device

2 Transparent element

3 Optical and optoelectronic device

4 Housing

5 Fluid inlet

6 Cleaning agent jet

7 Nozzle

8 Hydraulic channel

9 Optical axis

10 Pneumatic channel

11 Hydraulic nonreturn valve

12 Pneumatic nonreturn valve

13 Outer edge

14 Dosing valve

15 Connector

16 Electrical interface

17 Pump

18 Compressed air generator

19 Flow direction

20, 20′, 20″ Control line

1. A cleaning device for cleaning a transparent element of an optical or optoelectronic device with a fluid cleaning agent, comprising:
a housing in which the device is arranged,
at least one fluid inlet which is arranged in the housing, and
at least one nozzle which is supplied from the fluid inlet,
wherein the nozzle is designed to deflect the cleaning agent jet onto the transparent element, and the jet direction of the cleaning agent jet is provided substantially transversely to an optical axis of the transparent element,
wherein the fluid inlet is designed for a throughflow of a cleaning liquid out of a hydraulic channel and compressed air out of a pneumatic channel, and
wherein the hydraulic channel has a hydraulic nonreturn valve, and the pneumatic channel has a pneumatic nonreturn valve, said nonreturn valves opening the channels in the direction of the nozzle and blocking the channels in the opposite direction.

2. The cleaning device according to claim 1, wherein the transparent element has an outwardly curved design and the cleaning agent jet is substantially directed towards a radial outer edge of the transparent element so as to utilize a Coanda effect.

3. The cleaning device according to claim 2, wherein an operating pressure of the cleaning fluid in the hydraulic channel is provided to be greater than an operating pressure of compressed air in the pneumatic channel.

4. The cleaning device according to claim 3, wherein the operating pressure of compressed air in the pneumatic channel is provided to be within a range between 0.8 bar and 1.2 bar.

5. The cleaning device according to claim 1, wherein the pneumatic nonreturn valve is electrically controlled for targeted control of a throughflow of air flow.

6. The cleaning device according to claim 1, wherein a dosing valve for controlled variation of a compressed air amount entering the fluid inlet is provided in the pneumatic channel.

7. The cleaning device according to claim 1, wherein the compressed air is supplied to the fluid inlet in a continuously flowing manner.

8. Cleaning device according to claim 1, wherein the compressed air is supplied to the fluid inlet in a pulsed intermittent manner.

9. The cleaning device according to claim 1, wherein the cleaning agent jet is designed as a flat jet which substantially spreads in a plane orthogonal to the optical axis.

10. An optical capture system for arrangement in a vehicle, comprising at least one cleaning device according to claim 1.

11. The cleaning device according to claim 3, wherein the operating pressure of compressed air in the pneumatic channel is approximately 1 bar.
